(19) United States
(12) Patent Application Publication
(10) Pub. No.: US 2015/0198519 A1
(43) Pub. Date: Jul. 16, 2015

(54) CORROSION SENSING SYSTEMS AND METHODS INCLUDING ELECTROCHEMICAL CELLS ACTIVATED BY EXPOSURE TO DAMAGING FLUIDS

(71) Applicant: REGENTS OF THE UNIVERSITY OF MINNESOTA, Minneapolis, MN (US)

(72) Inventor: William H. Smyrl, New Brighton, MN (US)

(21) Appl. No.: 14/596,740

(22) Filed: Jan. 14, 2015

Related U.S. Application Data
(60) Provisional application No. 61/927,189, filed on Jan. 14, 2014.

(51) Int. Cl. G01N 17/02; H01M 6/32

(52) U.S. Cl. CPC G01N 17/02; H01M 6/32

(57) ABSTRACT

Systems and methods that can monitor corrosion are disclosed herein. In certain embodiments, the systems and methods can offer the capability of corrosion monitoring in remote locations without intrusion of wired connections.

This application claims the benefit of U.S. Provisional Application No. 61/927,189, filed Jan. 14, 2014, which is incorporated herein by reference in its entirety.

### BACKGROUND

Metals used in engineering structures in modern societies can be thermodynamically unstable in their service environments. The degradation reactions may be fast or slow, uniform or non-uniform, but often they are inevitable. The overall objectives of corrosion sensing are first to discover the presence of a damaging fluid at a given location, and second to monitor corrosion.

Most traditional monitoring techniques characterize the behavior of macroscopic samples either exposed to simulated conditions or exposed in service conditions. Known methods for studying corrosion degradation include, for example, linear polarization resistance (LPR), critical threshold concentrations of damaging species (e.g. chloride ions, or pH), resistivity of the damaging medium, and half cell potential measurements. These known methods average over sample area (i.e. corrosion rate by LPR), or determine the concentrations or permeation rates averaged over large dimensions. Additional methods for studying corrosion degradation have also been described for measurements in industrial conditions.

Known methods to study corrosion of exposed samples typically involve electrical connections to external instrumentation, which can be intrusive. Optical fibers can also be used as “wired” connections for spectroscopic detection of species, or for monitoring corrosion of metal films, and they are also intrusive. Instruments for monitoring corrosion under insulation (CU) have been developed which measure the change of resistance when condensed moisture penetrates insulation that covers pipes, for example.

There remains a need for new systems and methods for detecting and monitoring corrosion.

### SUMMARY

In one aspect, the present disclosure provides a system for sensing corrosion. In certain embodiments the system includes a sensor, and optionally a receiver and a monitor. The sensor can include, for example, one or more fluid activated batteries each including a cathode and an anode, wherein the one or more batteries each can produce a potential during contact with a damaging fluid; a transmitter in electrical communication with the one or more fluid activated batteries, wherein the transmitter transmits a wireless signal when activated by flow of current from the one or more activated batteries; and an electrically conductive member electrically connected between the one or more fluid activated batteries and the transmitter, wherein the electrically conductive member corrodes during exposure to the damaging fluid; and wherein corrosive failure of the electrically conductive member stops the current flow to the transmitter. An exemplary optional receiver can detect the wireless signal from the transmitter and provide information to an optional monitor. In certain embodiments, the optional monitor can record the time that current flow begins as the beginning of corrosion conditions, and the time that current flow stops as corrosive failure, wherein time to failure is the time between the beginning of corrosion conditions and corrosive failure.

In another aspect, the present disclosure provides a method for sensing corrosion. In certain embodiments, the method includes attaching a sensor to, or embedding a sensor within, a structural material, and optionally providing a receiver and a monitor. The sensor can include, for example, one or more fluid activated batteries each including a cathode and an anode, wherein the one or more batteries can each produce a potential during contact with a damaging fluid; a transmitter in electrical communication with the one or more fluid activated batteries, wherein the transmitter transmits a wireless signal when activated by flow of current from the one or more activated batteries; and an electrically conductive member electrically connected between the one or more fluid activated batteries and the transmitter, wherein the electrically conductive member corrodes during exposure to the damaging fluid; and wherein corrosive failure of the electrically conductive member stops the current flow to the transmitter. An exemplary optional receiver can detect the wireless signal from the transmitter and provide information to an optional monitor. In certain embodiments, the method can further include allowing the damaging fluid to contact the sensor and transmit a wireless signal to the optional receiver; and allowing the conductive member to corrode to failure and stop the current flow to the transmitter. In certain embodiments, the optional monitor records the time that current flow begins as the beginning of corrosion conditions, and the time that current flow stops as corrosive failure, and wherein the time to failure is the time between the beginning of corrosion conditions and corrosive failure.

Advantages of certain embodiments of the systems and methods disclosed herein can include, for example, the capability of corrosion monitoring in remote locations without intrusion of wired connections.

### Definitions

As used herein, a “microsensor” is a sensor that is small, and does not alter the conditions surrounding it.

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above brief description of various embodiments of the present invention is not intended to describe each embodiment or every implementation of the present invention. Rather, a more complete understanding of the invention will become apparent and appreciated by reference to the following description and claims in view of the accompanying drawings. Further, it is to be understood that other embodiments may be utilized and structural changes may be made without departing from the scope of the present invention.

### BRIEF DESCRIPTION OF THE DRAWINGS

FIG. 1 is a schematic illustration of an exemplary embodiment of a system for measuring time to failure from corrosion as described herein.

FIG. 2 is a schematic layout of an embodiment of miniature Mg—Ag/AgCl battery components having an assembled volume of 0.077 cm³.

FIG. 3 is a plot illustrating the impedance of an exemplary symmetrical cell of Ag/AgCl—Ag/AgCl with saturated KCl electrolyte.

FIGS. 4 and 5 are plots illustrating constant current discharge for exemplary Mg—Ag/AgCl cells with saturated KCl electrolyte.

### DETAILED DESCRIPTION OF ILLUSTRATIVE EMBODIMENTS

To overcome the problems of traditional approaches to characterize the corrosion of metals, it is desirable that new wireless sensors be (1) small so that they are not intrusive and do not alter local conditions; (2) inexpensive so that multiple units can be embedded at distributed locations; (3) tailored to enable unequivocal predictions of the metal corrosion process in technological conditions, and (4) robust to ensure durability before the onset of corrosion. In certain embodiments, the systems and methods of detecting and monitoring corrosion can meet at least some of these criteria.

Microsensors can offer the possibility of species detection, degradation rate determination, and flux measurements at local, small dimensions. With recent developments in microelectronics, micro-sized sensors are enabled as a new technology. Specialized sensors based on wireless communication and RFID technology offer an attractive new opportunity to deploy inexpensive units (Accenture, Radio Frequency Identification (RFID) White Paper, 2001). Small sensors monitor the local concentration of damaging species, and multiple sensors enable determination of damaging species distribution. Other sensors measure the corrosion rate of exposed specimen. It is often unnecessary to remove samples from the media to determine the level and distribution of specific species, and the corrosion rate as well. Whether they are adapted from passive or active devices, the sensors might be (a) embedded within engineering structures, (b) deployed in occluded regions or in remote locations, or (c) attached to external surfaces of vulnerable materials. In each case, the sensors could signal a component of the corrosion process without altering the conditions that cause corrosion.

Recent embedded sensors have been used either to determine damaging conditions for corrosion, or to measure degradation response to damaging conditions. Wireless threshold sensors have been studied in which a sensing steel wire component in a wireless passive sensor was interrogated with an inductively coupled magnetic monitor to determine the corrosion damage of steel in concrete test structures (Dickerson et al., Proc. SPIE 6174, Smart Structures and Materials 2006: Sensors and Smart Structures Technologies for Civil, Mechanical, and Aerospace System, 61741L (2006)). Corrosion of the wire disrupted the electrical connection and caused the sensor signal to fail (i.e. a time-to-failure (TTF) device). Sensors have been developed as a component of a wireless “Smart Pebble” to determine the concentration of chloride ion within the concrete of a bridge deck Watters et al., Proc. SPIE 5057, Smart structures and Materials 2003: Smart Systems and Nondestructive Evaluation for Civil Infrastructures, 20 (2003). Sensors have also been used in which the conductivity and temperature inside a concrete structure was monitored to signal the arrival of the damaging fluid (e.g. water and chloride ion) from the external surface (Andringa et al., Proc. SPIE 6529, Sensors and Smart Structures Technologies for Civil, Mechanical, and Aerospace Systems, 65293M (2007)). Low-cost sensors inductively-coupled with magnetic monitors to determine the onset of corrosion of a steel wire component within the passive (TTF) sensor have also been disclosed (Andringa et al., Sensors, 2005 IEEE, 155-158 (2005)). Prototype passive sensors have been introduced to monitor corrosion in concrete structures (Simonen et al., Proc. SPIE 5391, 587-596 (2005)). A passive wireless device for monitoring corrosion was disclosed in U.S. Patent Application Pub. No. 2009/0058427 A1 (Materer et al.). A network of distributed sensors that function with magnetic induction signals has also been described Chen et al., Proc. SPIE 7647, Sensors and Smart Structures Technologies for Civil, Mechanical, and Aerospace Systems, 764749, 1-9 (2010)). Another approach for a surface wetness sensor based on interdigitated electrode arrays (IDA) and RFID technology has also been disclosed (Yang et al., Biomed. Microdevices, 10: 1047-1054 (2008)). A different IDA sensor design has also been used for RFID sensing the conductivity around a sensor exposed to moisture (Ong et al., Sensors Journal, IEEE, 8:2053-2058 (2008)).

The use of RFID sensing to monitor chemical species, without addressing corrosion systems, has also been disclosed (Potyraillo et al., Anal. Chem. 79:45-51 (2007); Potyraillo et al., Wirel. Commun. Mob. Comput. 9:1318-1330 (2009)). The RFID response signal was analyzed to determine the “chemical shift” of the impedance as a signature of individual species. The approach is difficult to adapt to corrosion systems because of electrical interference for impedance measurements.

The discussion to follow here will focus on a miniature battery system that is inactive as assembled (“off”). It is activated when a damaging fluid flows into the inter-electrode separator (“on”). In the “on” state, it powers a wireless sensor that transmits a signal to the base station monitor to announce that corrosion conditions have been created at the location of the battery-sensor. Further, it powered the measurement of the time-to-failure (TTF) of a corroding specimen that was initiated when the fluid arrived (on), and ended when the specimen failed (off). The on/off action is a “large” signal that is insensitive to electrical noise from the ambient surroundings.

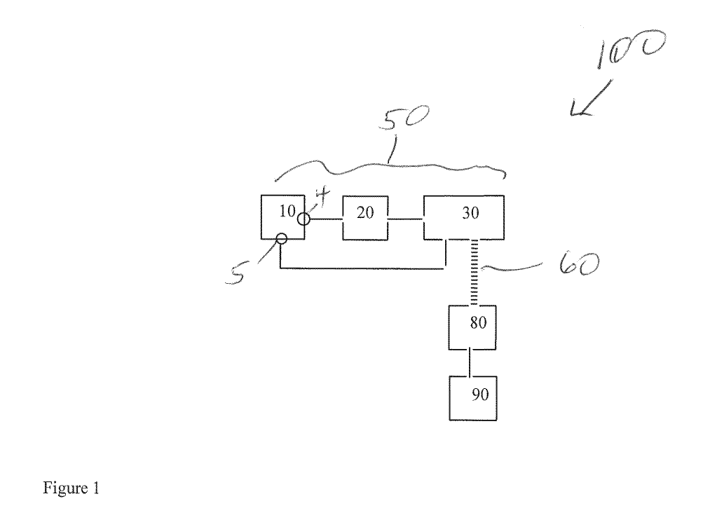

FIG. 1 is a schematic illustration of an exemplary embodiment of a system for measuring time to failure from corrosion as described herein. In some embodiments, system 100 can include sensor 50, and optional receiver 80 and optional monitor 90. In certain embodiments sensor 50 can be a microsensor. Sensor 50 can be attached to or embedded within a structural material such as insulation around pipes that transmit chemicals and other fluids, wherein spillage from the pipes could interrupt normal operations in chemical processing plants and refineries. The result of the spillage could be catastrophic and expensive, and warning by a sensor could enable preventive actions and maintenance.

Sensor 50 can include can include, for example, one or more fluid activated batteries 10 that can each produce a potential during contact with a damaging fluid. For embodiments in which sensor 50 includes more than one fluid activated battery 10, the batteries can be electrically connected in series, parallel, or a combination thereof as desired.

The one or more batteries 10 each include an anode and a cathode. In the embodiment illustrated in FIG. 1, battery 10 includes terminals 4 and 5. In certain embodiments, terminal 4 is electrically connected to the cathode and terminal 5 is electrically connected to the anode. In other certain embodiments, terminal 4 is electrically connected to the anode and terminal 5 is electrically connected to the cathode.

The one or more fluid activated batteries 10 can each produce a potential during contact with a damaging fluid. The damaging fluid is typically an aqueous fluid that can contain damaging ions. For example, the damaging fluid can be water, seawater, a chloride containing fluid, or a reactive liquid containing strong oxidants. Each of the one or more batteries 10 can further include a separator between the anode and the cathode. An exemplary separator includes paper.

A variety of cathodes and anodes can be utilized in each of the one or more batteries 10. Useful anodes include, but are not limited to, metals such as Zn and/or Mg. Useful cathodes include, but are not limited to, MnO₂, Cu/CuX (e.g., where X=Cl or Br), Ag/AgCl, and/or a TiO₂ nanotube Oxygen Reduction Reaction (TONT/ORR). One or more batteries 10 that include Cu/CuCl and/or Ag/AgCl cathodes can be particularly useful when the damaging fluid includes chloride ions. An exemplary battery 10 includes a Mg anode and a Ag/AgCl cathode, and the damaging fluid can include Cl⁻ ions. Additional useful batteries 10 that have large cell voltages include, for example, magnesium-air battery (fuel cells), zinc-air battery (fuel cells), aluminum-air battery (fuel cells), and iron-air (fuel cells), which would require fewer individual members to power the sensor transmitter components. For example, one magnesium-air battery/fuel cell has a voltage of 3 volts, which is approximately equivalent to two Mg—Ag/AgCl batteries. The use of batteries having large cell voltages can simplify the assembly of the sensor-battery, and can provide for longer time at which power is provided.

Sensor 50 can also include transmitter 30 in electrical communication with the one or more fluid activated batteries 10. Transmitter 30 can transmit wireless signal 60 when activated by flow of current from the one or more activated batteries 10. In certain embodiments, wireless signal 60 can be, for example, a 433 Mhz electrical signal that can be transmitted for many meters to an optional monitoring base station.

Sensor 50 can also include electrically conductive member 20 electrically connected between the one or more fluid activated batteries 10 and transmitter 30. Electrically conductive member 20 can corrode during exposure to the damaging fluid. Corrosive failure of electrically conductive member 20 can stop the current flow to transmitter 30, which can cause transmitter 30 to stop transmitting wireless signal 60.

An exemplary electrically conductive member 20 can include a copper film deposited on a substrate. The copper film can have a thickness of from 1 nm to 10 mm, in certain embodiments from 5 nm to 1 mm, and in other certain embodiments from 10 nm to 500 nm. In certain embodiments the electrically conductive member 20 is designed such that the time to failure (TTF) is within the activation lifetime of the sensor-battery system. In certain embodiments the substrate can be a polyester substrate. In other embodiments, electrically conductive member 20 can include, for example, a film deposited on a substrate, wherein the film comprises iron, steel, or other metal alloy that is susceptible to corrosion in the damaging fluid.

System 100 for measuring time to failure from corrosion can also include optional receiver 80 and optional monitor 90. Optional receiver 80 and optional monitor 90 can be located remotely from sensor 50. In certain embodiments, optional receiver 80 can receive wireless signal 60 (e.g., a 433 Mhz electrical signal) from transmitter 30.

An exemplary optional receiver 80 can detect wireless signal 60 from transmitter 30 and provide information to optional monitor 90 that records the time that current flow begins as the beginning of corrosion conditions, and the time that current flow stops as corrosive failure, wherein time to failure is the time between the beginning of corrosion conditions and corrosive failure. A wide variety of optional monitors 90 can be used. An exemplary optional monitor 90 can be a clocking device such as a processor.

In another aspect, the present disclosure provides a method for sensing corrosion. In certain embodiments, the method includes attaching a sensor to, or embedding a sensor within, a structural material. Optionally, the method further includes providing a receiver and a monitor. The sensor (e.g., a microsensor) can include, for example, one or more fluid activated batteries each including a cathode and an anode, wherein the one or more batteries can each produce a potential during contact with a damaging fluid; a transmitter in electrical communication with the one or more fluid activated batteries, wherein the transmitter transmits a wireless signal when activated by flow of current from the one or more activated batteries; and an electrically conductive member electrically connected between the one or more fluid activated batteries and the transmitter, wherein the electrically conductive member corrodes during exposure to the damaging fluid; and wherein corrosive failure of the electrically conductive member stops the current flow to the transmitter. An exemplary optional receiver can detect the wireless signal from the transmitter and provide information to an optional monitor that records the time that current flow begins as the beginning of corrosion conditions, and the time that current flow stops as corrosive failure. In some embodiments, the method further includes allowing the damaging fluid to contact the sensor and transmit a wireless signal to the optional receiver to indicate the beginning of corrosion conditions; allowing the conductive member to corrode to failure and stop the current flow to the transmitter to indicate corrosive failure of the electrically conductive member; and determining the time to failure as the time between the beginning of corrosion conditions and corrosive failure.

The present invention is illustrated by the following examples. It is to be understood that the particular examples, materials, amounts, and procedures are to be interpreted broadly in accordance with the scope and spirit of the invention as set forth herein.

### EXAMPLES

### Miniature Battery Assembly

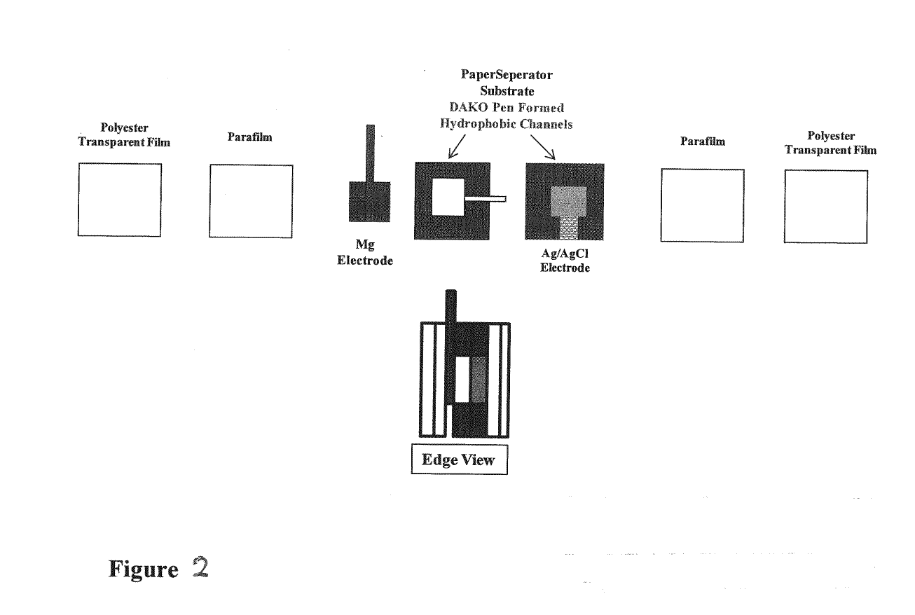

The fabrication of miniature Mg—Ag/AgCl battery is described first for the inactive (or “off”) state. A schematic of the cell components of a typical miniature cell is shown in FIG. 2. This layout has been found to be effective in previous studies of flexible fuel cells. See, for example, Wheldon et al., Electrochem. Solid-State Lett., 12: B86-B89 (2009); Lim, et al., Electrochem. Solid-State Lett., 12:B123-B125 (2009); and Lim et al., J. Electrochem. Soc., 157:B862-B867 (2010). In the present study, a paper substrate separates the two electrodes and is the host for the electrolyte (damaging fluid) when it arrives. The damaging fluid is absorbed into a tab of the separator outside the cell and it then flows by capillary action into the inter-electrode region of the assembly. A DAKO pen (DAKO Corporation, Carpineria, Calif.) was used to create hydrophobic channels and regions in the paper separator. The paper used here is either chromatography paper of medium porosity (Whatman #3001-861), filter paper of high porosity (Whatman #1), or treated samples of either. These papers have few components that could contaminate the fluid and compromise the results. The anode electrode studied here was formed from magnesium foil (99.9% purity, Atomergic Chemicals, Farmingdale, N.Y.). The counter electrode was a Cl⁻ ion reversible electrode, Ag/AgCl, that was coated from a fluid ink (AGCL 675 Silver/Silver Chloride, Conductive Compounds, Hudson, N.H.). The composition of the AGCL ink had approximately equal mass of Ag and of AgCl, from which the coulombic loading of electrodes was calculated.

When the damaging fluid arrived at the electrode region, the cell was activated (“on” state). Results for magnesium-silver/silver chloride electrochemical cells that are activated by arrival of potassium chloride solution as the damaging fluid are disclosed herein.

### Testing of Water-Activated Cells

The Ag/AgCl electrodes were coated with the AGCL ink through a template onto the separator and dried for approximately 3 days at ambient laboratory conditions. The mass of the electrode material was determined by weighing the paper substrate before and after the active material was coated. The mass was measured with an analytical balance to an accuracy of 0.1 mg. Three day drying times were sufficient to achieve a constant final weight. A metal tab from the electrode was formed by coating with narrow strip of silver ink (PELCO Colloidal Silver Liquid #16031, Ted Pella, Redland, Calif.) that extended to the edge of substrate. This tab provided a contact and current collector for the electrode. The open circuit potential (OCP) of the coated electrodes was measured vs. a commercial Saturated Calomel Electrode (SCE) with a Solartron 1287 Electrochemical Interface. The fabricated electrodes were stored in the dry state in a darkened location.

Magnesium electrodes were cut from a metal foil sheet. The foils were etched in 0.1N HCl for several minutes to remove accumulated oxides and residual impurities that remained from the commercial forming and rolling processes. The foil was cut to the final size with a tab that extended outside the edge of the cell for connection to the current collector lead.

The miniature cells were assembled from the components as shown in FIG. 2, and treated with a pouch edge-sealer around all sides of the electrolyte region to confine the damaging fluid to the electrode region when it was introduced into the cell from the absorbent paper tab.

Once the (damaging fluid) electrolyte was added to the tab, it flowed rapidly into the cell by capillary action, and the cell was activated (“on” state) within a few minutes. The activation was very stable and reproducible. The open circuit potential of the activated cell was 1.65V.

Impedance analyses were carried out on symmetrical Ag/AgCl—Ag/AgCl cells with the electrolyte soaked (satd KCl) paper separator (thickness of 0.017 cm). A Solartron 1260 Impedance/Gain Phase Analyzer was used with a LabView controller program developed in our laboratory. The cells were very stable and reproducible.

Constant current (galvanostatic) discharge was carried out on activated Mg—Ag/AgCl cells (“on” state) at several current levels. A Solartron 1287 Electrochemical Interface was used with a LabView software controller (Steinbach, Andrew James, “REVERSIBLE PERFORMANCE STABILITY OF POLYMER ELECTROLYTE MEMBRANE FUEL CELLS”, Master of Science Thesis, University of Minnesota, 2008). The change from “off” to “on” was triggered by the arrival of the damaging fluid, and this provided the power for a wireless transmitter and monitor system.

Discussion follows of a corrosion measurement activated by arrival of a damaging fluid. The corrosion measurement will be in the form of an “on/off” action that measures the time-to-failure (TTF) of the corroding sample. In later studies, other measurement of corrosion rate will be powered by the activated battery.

### Results and Discussion

### Testing of the Ag/AgCl Electrode

The Ag/AgCl electrode was coated by applying the liquid ink to the absorbent paper through a template. The mass loading was determined by weight change on an analytical balance with 0.1 mg accuracy. The OCP was independent of mass loading. The OCP of the electrode vs a Saturated Calomel Electrode was determined with a Solartron 1287 Electrochermical Interface. The potential was determined in a saturated potassium chloride solution in deionized water (>17.9 Mohm resistivity). Both electrodes were immersed in the electrolyte in one test, or the SCE was contacted with the wetted paper substrate on which the Ag/AgCl electrode had been coated in other tests. Both measurements gave identical OCPs. The OCP was independent of mass loading. The Ag/AgCl electrodes were very stable and reproducible, and the potential was −0.042V vs SCE for a saturated KCl electrolytic solution (the damaging fluid in the present study). The literature value of the OCP for a Ag/AgCl electrode is −0.045 V vs SCE when tested in saturated KCl solutions at ambient laboratory temperatures (25° C.) (Bard, A. J. and L. R. Faulkner, Electrochemical Methods, 2nd ed, John Wiley and Sons, NJ (2001)). The Ag/AgCl electrodes were very stable and reproducible, and demonstrated behavior that is identical to that of standard Ag/Ag/Cl (Ives, D. J. G. and G. J. Janz, eds Reference Electrodes, Academic, New York (1961)).

### Impedance Measurements of the Ag/AgCl Electrode

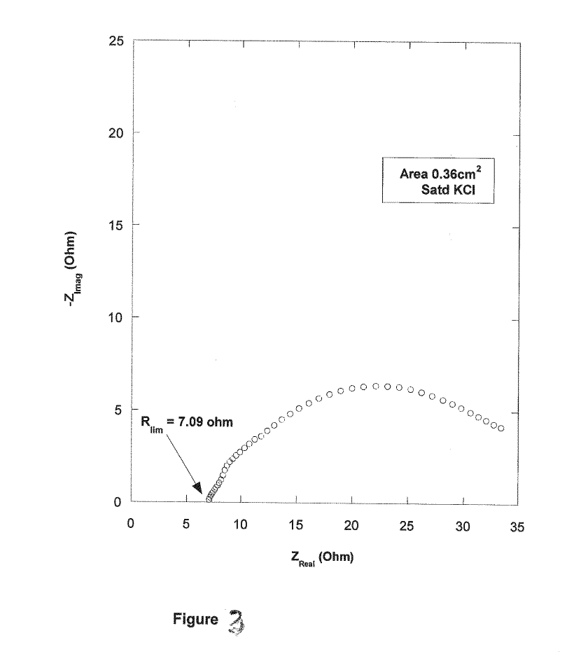

Impedance measurements of symmetrical electrode cells were carried out on a Solartron 1260 Impedance Gain Phase/Analyzer with Labview software. The electrodes (equal area of 0.36 cm²) faced one another across a paper separator (thickness of 0.017 cm) wetted with saturated potassium chloride solution. The cells were assembled like that shown in FIG. 2. The impedance behavior was very stable and reproducible over time and for several assembled cells. Results are shown in FIG. 3. The high frequency impedance shows a limiting resistance, Rₗᵢₘ, of 7.09 ohms. This value includes the resistance of the electrolyte filled paper separator, and contact and current collector resistances. The dimensions of the paper separator and electrode area, along with the conductivity of the KCl solution (0.35825 ohm⁻¹ cm⁻¹, Nickels et al., J. Phys. Chem. 41:861-872 (1937)) yielded the calculated resistance of the electrolyte phase alone to be 0.133 ohms.

The depressed semicircle(s) of the Cole-Cole plot agree with published results (Rhodes et al., Anal. Chim. Acta, 113:55-66 (1980)), and will not be analyzed further here. The reduction of AgCl to Ag changes the relative amounts of the two, but does not change the electrode potential so long as both are present. The Ag/AgCl electrode is expected to perform well on discharge in the Mg—Ag/AgCl cells.

### Discharge Characteristics of Mg—Ag/AgCl Cells

The Mg—Ag/AgCl cell has the following reactions for cell discharge

Mg(s)=Mg⁺²(soln)+2 e⁻ (oxidation)

AgCl(s)+e⁻=Ag(s)+Cl⁻(soln) (reduction)

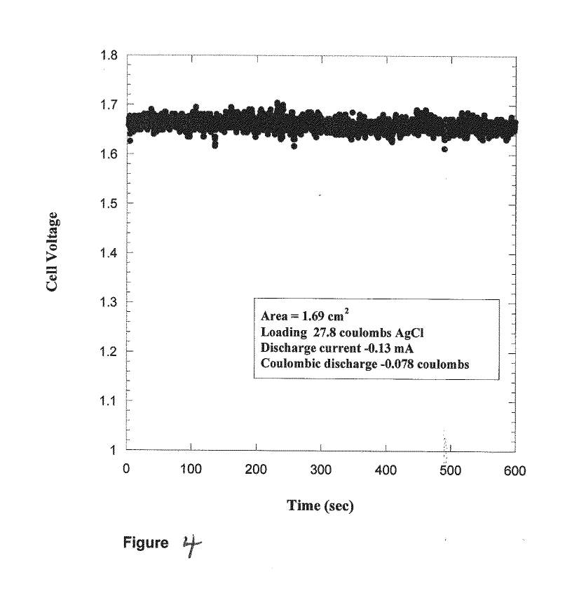

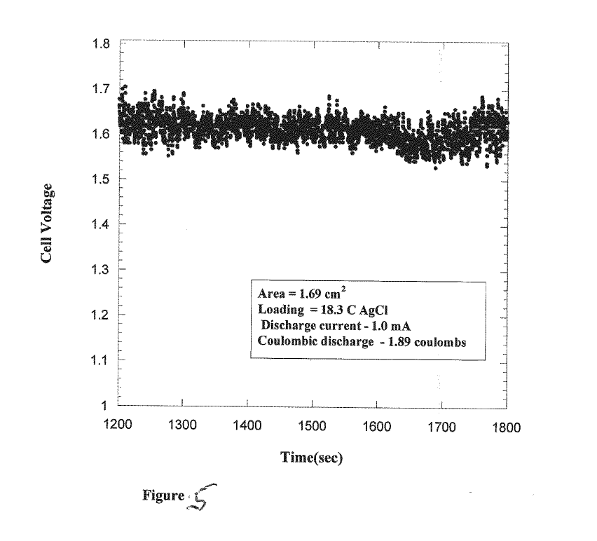

Discharge characteristics of the activated (“on”) miniature cells have been studied with galvanostatic discharge. The Ag/AgCl electrode limits the discharge capacity in the results given here. The mass loading of the Ag/AgCl material is approximately 50/50 silver/silver chloride solids (MSDS sheets for AGCL liquids, Conductive Compounds). For a typical mass loading of 0.0350 to 0.0920 grams for electrodes with an area of 1.69 cm², the loading of AgCl is calculated to be 7.28×10⁻⁵ to 1.19×10⁻⁴ moles/cm². This corresponds to a coulombic capacity of the Ag/AgCl electrode of 7.02 to 18.46 coulombs/cm². The loadings were compared to the discharge capacities measured in the cells for a selected current and time. In FIG. 4 is shown the discharge time of 600 seconds and a total coulombic charge of −0.078 coulombs. The voltage of the cell was nearly constant at 1.65 V for the entire discharge, as expected for the short time and low current (only approximately 1% of the total coulombic capacity of the Ag/AgCl electrode was consumed). Another cell was discharged for a longer time as shown in FIG. 5. The latter portion of the discharge (1200-1800 seconds) emphasizes that the average voltage was nearly constant even to the end of the selected discharge time. The current of 1 mA is relatively high for the expected service of the cells in wireless operation, as will be discussed below.

It is believed that the Mg—Ag/AgCl cell will support a wireless signal for an hour or more to indicate that the battery is “on” when activated. This has been explored in a proof-of-concept series of tests as will be discussed now.

### Wireless Transmission Supported by the Mg—Ag/AgCl Cell

To transmit a signal to a remote monitor that the damaging fluid has arrived, a commercial wireless system that is normally powered by 2 AAA batteries (Springfield Wireless Digital Sensor, Model 91905, Wood-Ridge, N.J., transmission at 433 Mhz) was utilized. The system draws approximately 10-15 microamps current from the batteries in series, and transmits a signal approximately 100 feet to a remote monitor station. The system is normally used as an outdoor temperature sensor, and was adapted for sensing the activation of Mg—Ag/AgCl batteries. It is noted that the results above have shown that the cells have sufficient voltage (2 cells in series) and current to power the operation of the sensing system.

It has been confirmed that 2 Mg—Ag/AgCl batteries in series will turn on the sensor when a damaging fluid arrives to activate the cells. The cells turn on the sensor and this transmits an “on” signal to the base station. There is sufficient power for continuous operation of an hour or more, depending on the coulombic loading of AgCl on the electrodes. This provides a warning that the critical conditions for corrosion have been detected at the location of the battery-sensor.

Wireless Detection of Corrosion with Mg—Ag/AgCl Batteries

The second stage of the study includes situation in which corrosion is monitored—not just the conditions for corrosion. In order to do this, a time-to-failure (TTF) measurement was used. From the time that the damaging fluid arrives to create corrosion until the test specimen is consumed determines the TTF. The specimen is a thin film of copper (100 nanometers thick) evaporated onto a polyester substrate. A strip of the Cu film was connected in series with the batteries in a similar setup to that used to announce the arrival of the damaging fluid. The second sensor continues to report the presence of damaging fluid, until the Cu film is finally consumed by corrosion in the fluid. This breaks the connection for operation of the second sensor (i.e., change from on to off), and the TTF of 54 minutes was measured for multiple samples in saturated KCl. It was exposed to the damaging fluid (saturated KCl) by placing it onto a wetted strip of chromatography paper. Electrical leads were attached to the Cu film sample and it was placed in series with two Mg—Ag/AgCl batteries, and then to the wireless sensor circuitry. The system continued to operate until the film was corroded through which turned off the power and this turned off the signal transmitted to the base station monitor. The batteries had sufficient capacity for the entire period of the TTF test, and this was repeated for each of the multiple copper film samples.

It is noted that a TTF measurement has both an induction or initiation period and a propagation period for corrosion. Because the time for total removal of the metal film thickness (here 100 nm of Cu) includes both initiation and propagation periods, the TTF period may not be a precise indicator of the rate of corrosion. Further, the corrosion rate of metals often changes with time as well. Nonetheless, the TTF method can have value as an indication of corrosion by a damaging fluid.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A system for sensing corrosion comprising:
one or more fluid activated batteries each comprising a cathode and an anode, wherein each of the one or more batteries can produce a potential during contact with a damaging fluid;
a transmitter in electrical communication with the one or more fluid activated batteries, wherein the transmitter transmits a wireless signal when activated by flow of current from the one or more activated batteries; and
an electrically conductive member electrically connected between the one or more fluid activated batteries and the transmitter, wherein the electrically conductive member corrodes during exposure to the damaging fluid; and wherein corrosive failure of the electrically conductive member stops the current flow to the transmitter.

2. The system of claim 1 further comprising a receiver that detects the wireless signal from the transmitter and provides information to a monitor.

3. The system of claim 2 wherein the monitor records the time that current flow begins as the beginning of corrosion conditions, and the time that current flow stops as corrosive failure, wherein time to failure is the time between the beginning of corrosion conditions and corrosive failure.

4. The system of claim 1 wherein the sensor is attached to or embedded within a structural material.

5. The system of claim 2 wherein the receiver and monitor are located remotely from the sensor.

6. The system of claim 1 wherein the anode is a metal anode comprising Zn and/or Mg.

7. The system of claim 1 wherein the cathode comprises MnO₂, Cu/CuCl, Cu/CuBr, Ag/AgCl, and/or a TiO₂ nanotube Oxygen Reduction Reaction (TONT/ORR).

8. The system of claim 1 wherein the anode is a metal anode comprising Mg, the cathode comprises Ag/AgCl, and the damaging fluid comprises Cl⁻ ions.

9. The system of claim 1 wherein each of the one or more batteries further comprises a separator between the anode and the cathode.

10. The system of claim 1 wherein the electrically conductive member comprises a copper film deposited on a substrate.

11. The system of claim 10 wherein the copper film has a thickness of from 1 nm to 10 mm.

12. The system of claim 1 wherein the electrically conductive member comprises a film deposited on a substrate, wherein the film comprises iron, steel, or other metal alloy that is susceptible to corrosion in the damaging fluid.

13. A method for sensing corrosion comprising attaching a sensor to, or embedding a sensor within, a structural material, wherein the sensor comprises:
one or more fluid activated batteries each comprising a cathode and an anode, wherein each of the one or more batteries can produce a potential during contact with a damaging fluid;
a transmitter in electrical communication with the one or more fluid activated batteries, wherein the transmitter transmits a wireless signal when activated by flow of current from the one or more activated batteries; and
an electrically conductive member electrically connected between the one or more fluid activated batteries and the transmitter, wherein the electrically conductive member corrodes during exposure to the damaging fluid; and wherein corrosive failure of the electrically conductive member stops the current flow to the transmitter.

14. The method of claim 13 further comprising:
providing a receiver that detects the wireless signal from the transmitter and provides information to a monitor;
allowing the damaging fluid to contact the sensor and transmit a wireless signal to the receiver; and
allowing the conductive member to corrode to failure and stop the current flow to the transmitter.

15. The method of claim 14 wherein the monitor records the time that current flow begins as the beginning of corrosion conditions, and the time that current flow stops as corrosive failure, and wherein the time to failure is the time between the beginning of corrosion conditions and corrosive failure.

16. The method of claim 13 wherein the anode is a metal anode comprising Zn and/or Mg.

17. The method of claim 13 wherein the cathode comprises MnO₂, Cu/CuCl, Cu/CuBr, Ag/AgCl, and/or a TiO₂ nanotube Oxygen Reduction Reaction (TONT/ORR).

18. The method of claim 13 wherein the anode is a metal anode comprising Mg, the cathode comprises Ag/AgCl, and the damaging fluid comprises Cl⁻ ions.

19. The method of claim 13 wherein the electrically conductive member comprises a copper film deposited on a substrate.

20. The method of claim 13 wherein the electrically conductive member comprises a film deposited on a substrate, wherein the film comprises iron, steel, or other metal alloy that is susceptible to corrosion in the damaging fluid.
